(19) United States
(12) Patent Application Publication
(10) Pub. No.: US 2007/0054682 A1
(43) Pub. Date: Mar. 8, 2007

(54) Broadband carrier frequency selection

(75) Inventors: Neil Fanning, Bristol (GB); Steve Carl Jamieson Parker, Bristol (GB); Jiun Siew, Bristol (GB); Siew Chung Leong, Bristol (GB); Rafael Arcangel Cepeda Lopez, Bristol (GB)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Minato-ku (JP)

(21) Appl. No.: 11/414,310

(22) Filed: May 1, 2006

(30) Foreign Application Priority Data
Sep. 5, 2005 (GB) 0518038.5

(51) Int. Cl. H04Q 7/20; H04B 7/00

(52) U.S. Cl. 455/509

(57) ABSTRACT

The present invention relates to broadband wireless communication using multiple carrier frequencies, and the selection or allocation of those frequencies. The invention is particularly but not exclusively related to ultra wideband (UWB) technologies. The present invention provides a method of dynamically selecting carrier frequencies for carrying a broadband channel, the method comprising: allocate a group of carrier frequencies for carrying the broadband channel; identify a number of alterative groups of carrier frequencies; monitor channel performance of the broadband channel for the allocated group of carrier frequencies; re-allocate the broadband channel to be carried by one of the alternative groups of carrier frequencies in response to the monitored channel performance degrading below a threshold.

### FIELD OF THE INVENTION

The present invention relates to broadband wireless communication using multiple carrier frequencies, and the selection or allocation of those frequencies. The present invention is particularly but not exclusively related to ultra wideband (UWB) technologies.

### BACKGROUND OF THE INVENTION

Ultra-wideband (UWB) wireless communication is gaining increasing attention as a short range high data rate wireless technology, particularly for personal area networks and other mobile data transfer applications over a short distance. UWB transmission power is spread over a wide bandwidth, typically greater than 25% of the centre frequency used.

There are currently two main competing UWB implementations, direct sequence or DS-UWB and multi-band OFDM or MB-OFDM. DS-UWB is “carrier-less” system and uses spreading codes within two frequency bands, 3.1-4.85 GHz and 6.2-9.7 GHz; and is supported by the UWB forum. These systems utilise very short duration pulses, which are filtered typically by antenna design into the desired frequency bands. By contrast MB-OFDM utilises a number of sub-carriers or tones in a number of bands together with a time-frequency hoping sequence or code to define a channel; and is supported by the Multi-band OFDM alliance (MBOA). Each OFDM band of orthogonal sub-carrier frequencies provides OFDM symbols, and the MBOA has proposed several band groups, each containing two or three bands of OFDM tones. The proposed band groups are shown in FIG. 1. For each band group, time-frequency codes (TFC) define the sequence of bands used over a time frame for each OFDM symbol transmission. The TFC are defined over six symbol periods, and with the five band groups shown in FIG. 1, provide for eighteen logical channels.

The two UWB technologies both utilise the unlicensed 3.1-10.6 GHz band, as regulated in the United States by the Code of Federal Regulations, Title 47, and Section 15. This band is also used by other broadband wireless access technologies such as the very pervasive IEEE802.11x (Wi-Fi). The issue of interference between these narrow band systems and UWB systems is therefore hotly debated. In common with these narrow band technologies, because of the moderately high frequencies involved, signal losses due to path losses and material and body absorption are also important issues, especially in indoor environments where these technologies are typically employed.

### SUMMARY OF THE INVENTION

In general terms the present invention provides a diversity scheme for broadband channels using multiple carrier frequencies in which the carrier frequencies are dynamically selected depending on channel conditions. Thus as conditions degrade for the current set of carrier frequencies, a new set of carrier frequencies can be allocated to provide the broadband channel. This arrangement is well suited to the UWB multi-band OFDM (MB-OFDM) proposal which uses band groups and time-frequency codes to implement multiple access channels within each band group; however the arrangement is not limited to this proposal and could be implemented for other suitable broadband wireless technologies.

In an embodiment a number of groups of carrier frequencies or band groups are predefined and are dynamically allocated to bear the broadband (eg UWB) channel depending on conditions within the signal propagation environment, and/or the network (eg piconet) supported by the broadband channel. For example if the channel is currently carried within band group 2 as defined by MBOA, but an IEEE802.11g channel appears and interferes with the existing UWB channel, the UWB channel can be re-allocated to be borne by OFDM symbols in band group 1 or 3 for example. This arrangement allows for dynamic avoidance of inter-system interference as well as changing propagation conditions such as moving objects or changing distances between transmitter and receiver.

In one aspect there is provided a method of dynamically selecting carrier frequencies for carrying a broadband channel, the method comprising: allocate a group of carrier frequencies for carrying the broadband channel; identify a number of alterative groups of carrier frequencies; monitor a performance parameter of the broadband channel for the allocated group of carrier frequencies; re-allocate the broadband channel to be carried by one of the alternative groups of carrier frequencies in response to the monitored channel performance degrading below a threshold.

The performance parameter may comprise or be dependent on a channel performance measurement such as SNIR and/or a network performance measurement such as actual throughput as a percentage of throughput set by a Quality of Service (QoS) level. Further examples include received carrier power; interference power; information error rate; estimated distance between transceivers; throughput; power reserves; transceiver density.

In an embodiment the broadband channel is a MB-OFDM UWB channel and the groups of carrier frequencies correspond to OFDM symbols in respective predefined band groups.

In an embodiment a performance parameter is determined for each group of carrier frequencies, and the initially allocated group of carrier frequencies is the group with the highest determined performance parameter. The broadband channel can then be re-allocated to the alternative group of carrier frequencies having the next highest determined performance parameter.

Alternatively the initial allocation is to a default group of carrier frequencies, and the method further comprises determining a performance parameter for a number of other groups of carrier frequencies in order to identify the alternative groups of carrier frequencies. This may be determined by a “centralised” coordinator device which forwards the carrier groups together with scores in a scoring matrix to user devices for implementing switching between the groups depending on the currently monitored performance parameter for the currently allocated band group or group of carrier frequencies.

The threshold may be a performance parameter determined for one of the alternative groups of carrier frequencies or a predetermined measurement metric value.

In an embodiment, parts of a dynamic band group algorithm (carrier frequency carrier group selection method) for switching between band groups (predetermined groups of carrier frequencies) depending on current channel and network conditions (performance parameter) are distributed to different devices within a network or system of UWB enabled devices. The allocated and alternative groups of carrier frequencies are determined by a coordinator device and forwarded to a user device communicating with the broadband channel; and the re-allocation step is taken by the user device having received and stored the allocated and alternative groups of carrier frequencies (eg in a scoring matrix). The performance parameter monitoring step is taken at the user device.

The algorithm may further comprise: initially allocating a default group of carrier frequencies (at the coordinator device); determining a performance data structure comprising performance metrics associated with the initially allocated group of carrier frequencies (at the user device); feeding back the data structure (from the user device) to the coordinator for processing with other data structures feedback from other user devices in order to determine a scoring matrix identifying the alternative groups of carrier frequencies; receiving the scoring matrix (at the user devices) from the coordinator.

There is also provided a method of re-allocating carrier signals in a broadband channel comprising a plurality of carrier signals, the method comprising: measuring a channel quality parameter for the broadband channel; determining for a number of predetermined groups of carrier frequencies an estimated group quality parameter; re-assigning the predetermined group of carrier frequencies having the best estimated group quality parameter to the broadband channel.

This may further comprise: storing a list of predetermined groups of carrier frequencies and their respective estimated group quality parameters; re-assigning the predetermined group of carrier frequencies having the next best estimated group quality parameter to the broadband channel in response to the measured channel quality parameter for the broadband channel falling below a predetermined minimum.

In another aspect there is provided a method of allocating groups of carrier frequencies for carrying a broadband channel for a coordinator apparatus, the method comprising: determining channel performance parameters for a number of groups of carrier frequencies for carrying the broadband channel; allocating the group of carrier frequencies for carrying the broadband channel having the best channel performance parameter; identifying a number of alterative groups of carrier frequencies for re-allocating the broadband channel to when the measured channel performance parameter degrades below a predetermined threshold.

In another aspect there is provided a method of dynamically selecting carrier frequencies for carrying a broadband channel for a user device, the method comprising: receiving an allocated group of carrier frequencies for carrying the broadband channel;
receiving a number of alterative groups of carrier frequencies; measuring a channel performance parameter for the broadband channel; re-allocating the broadband channel to be carried by one of the alternative groups of carrier frequencies in response to the measured channel performance parameter degrading below a predetermined threshold.

The present invention also provides corresponding systems, apparatus and computer programs.

### BRIEF DESCRIPTION OF THE DRAWINGS

Embodiments are now described with reference to the drawings, by way of example only and without intending to be limiting, in which:

FIG. 1 illustrates band groups 1-5 of the MBOA proposal at the microwave ISM band;

FIG. 2 illustrates interference with a DS-UWB low mode device;

FIG. 3 illustrates interference with a DS-UWB high mode device;

FIG. 4 illustrates interference with an IEEE802.11a or n device;

FIG. 5 illustrates additional MB-OFDM band groups at millimetre-wave ISM band;

FIG. 6 illustrates a method of dynamically selecting groups of carrier frequencies for UWB channels according to an embodiment;

FIG. 7 illustrates a group of piconets supported by multiple UWB channels;

FIG. 8 illustrates band groupings for a collection of piconets;

FIG. 9 illustrates band groupings for a collection of piconets according to a dynamic selection algorithm according to an embodiment;

FIG. 10 illustrates a method of operating a UWB device according to an embodiment;

FIG. 11 illustrates a method of operating a parent piconet coordinator UWB device according to an embodiment;

FIG. 12 illustrates a method of operating a child piconet coordinator UWB device according to an embodiment; and

FIG. 13 illustrates a schematic of a UWB device according to an embodiment.

### DETAILED DESCRIPTION OF EMBODIMENTS

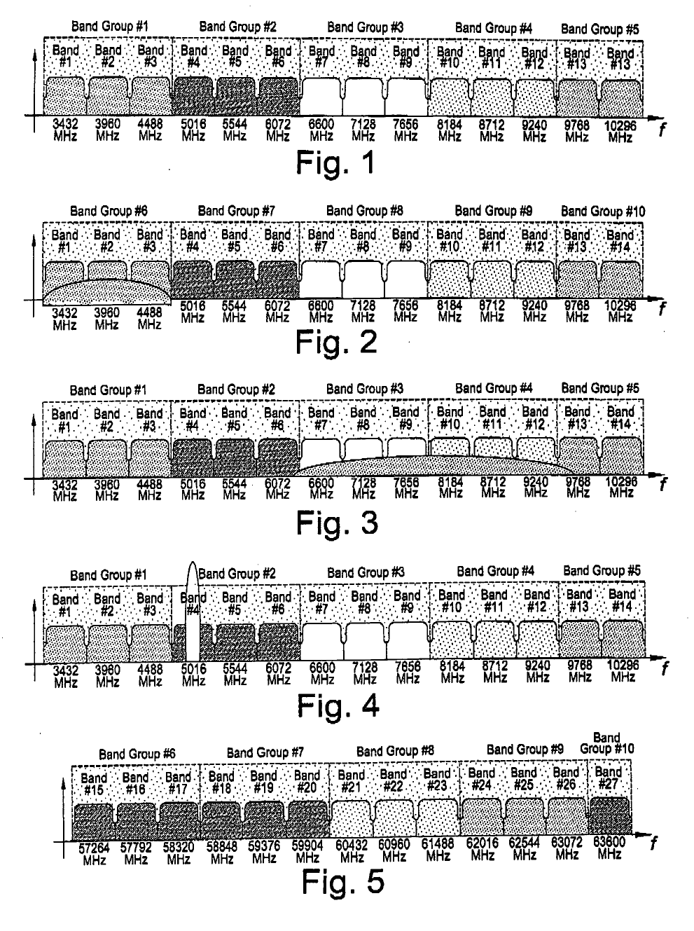

FIG. 1 shows the frequency allocations of the bands and band groups for the MBOA proposal, which utilise the 3.1-10.6 GHz band. Table 1 below shows all 14 OFDM physical channels or sub-carrier frequency bands, each having a spacing of 528 MHz. Each OFDM channel is a collection of 122 modulated and pilot tones or orthogonal sub-carrier frequencies with together produce an OFDM symbol for that channel.

TABLE 1

| | | Band ID | | | |
|---|---|---|---|---|---|
| Operating | Band | (Channel | Lower | Centre | Upper |
| Mode | Group | No.) | Frequency | Frequency | Frequency |
| I | 1 | 1 | 3168 | 3432 | 3696 |
| | | 2 | 3696 | 3960 | 4224 |
| | | 3 | 4224 | 4488 | 4752 |
| II | 2 | 4 | 4752 | 5016 | 5280 |
| | | 5 | 5280 | 5544 | 5808 |
| | | 6 | 5808 | 6072 | 6336 |
| III | 3 | 7 | 6336 | 6600 | 6864 |
| | | 8 | 6864 | 7128 | 7392 |
| | | 9 | 7392 | 7656 | 7920 |
| IV | 4 | 10 | 7920 | 8184 | 8448 |
| | | 11 | 8448 | 8712 | 8976 |
| | | 12 | 8976 | 9240 | 9504 |
| V | 5 | 13 | 9504 | 9768 | 10032 |
| | | 14 | 10032 | 10296 | 10560 |

As noted above, the proposed UWB system, as defined by the MBOA physical layer proposal to IEEE 802.15.3a, specifies the use of time-frequency codes (TFCs) to interleave coded data over three frequency bands (known as a band group). Four such band groups and an additional band group with two frequency bands are defined. These band groups together with TFCs provide the capability of the system to support eighteen separate logical channels or independent piconets.

The TFCs define for each channel which band of their band group they will use at a particular time within a time frame. Each channel hops between different bands in a well defined sequence over time. A total of eighteen logical channels are available over the 5 defined band groups.

However the TFCs only interleave data within the allocated band group and not across the entire 7.5 GHz band. This has the limitation that if the entire band group is suffering from interference, then TFCs will not be sufficient to combat the problem.

Furthermore, as the current UWB band spans up to moderately high frequencies around 10 GHz and potentially very high frequency bands around 60 GHz in the future; path losses, material and body absorptions can be a significant factor. Therefore the range between the transmitter and the receiver can be severely limited. Given the fact that Wireless Personal Area Network (WPAN) devices are more likely to be used in an indoor environment, the channel can therefore be very complex. For instance, in an office there may be several technologies being used. Notably, IEEE 802.11a and 802.11n devices use the 5 GHz band, which directly coincide with Band Group 2. At the time of writing, the 5 GHz band is entirely avoided by the Multi-band OFDM Alliance (MBOA).

In addition, satellite, navigation and military systems also occupy some of the bands within 3.1-10.6 GHz, although FCC has tried its best to curb UWB interference by introducing a strict spectral mask. For a UWB system, even with a robust physical layer design, it could still suffer interference from other systems (inter-system interference). In a multi-user scenario, devices sharing the same Band Group could cause intra-system interference with each other.

FIG. 2 illustrates a case where a MB-OFDM Mode I (ie band group 1) device is suffering interference from a DS-UWB device, operating in the lower frequencies or Low-Mode (3.1-4.85 GHz, 1.368 GHz of bandwidth in total) across the whole of Band Group 1.

FIG. 3 shows a DS-UWB device operating in higher frequencies or High-Mode (6.2-9.7 GHz, 2.736 GHz bandwidth in total) which causes interference to Band Groups 3 and 4, and some of Band Groups 2 and 5.

In FIG. 4, Band (channel) 4 of Band Group 2 is suffering interference from narrow band IEEE 802.11a or 0.11n devices operating at 5.2 GHz.

FIG. 5 illustrates a further proposal for frequency allocation bands and band groups at 60 GHz for the US and Japan spectrum regulations—the millimetre-wave bands. Although current RF front end technologies for millimetre-wave applications are still expensive, some means of up or down conversion from the same physical layer as in the microwave band is rather straight forward.

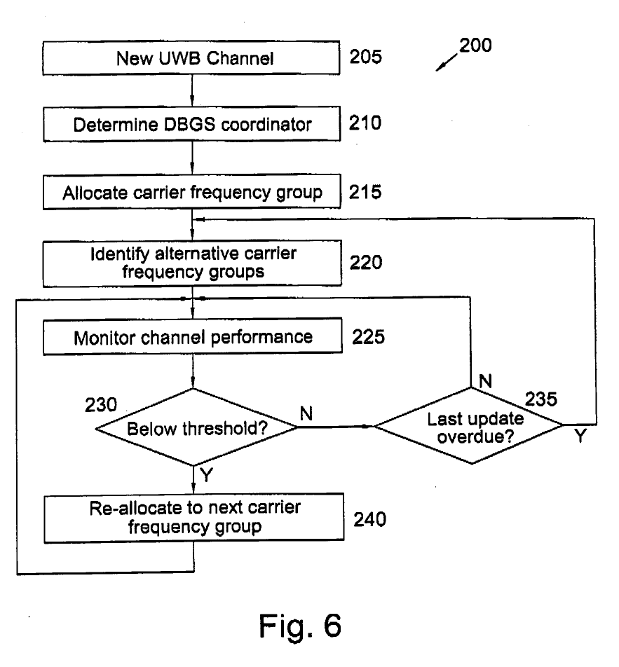

FIG. 6 illustrates a method of allocating carrier frequencies to a broadband channel according to an embodiment. The broadband channel may be a UWB channel associated with a piconet or personal area network (PAN) for example, which may provide data transfer capabilities between a Smartphone and a Laptop PC. The corresponding transceivers may be capable of all 27 bands defined above, or a sub-set of these, for bearing the UWB channel. As noted above, each UWB channel will be restricted to a band group (1-10 say), and will have a predefined time-frequency code TFC in order to distinguish it from other UWB channels within the same band group.

The embodiment uses a diversity technique involving multiple UWB frequency band groups. A Dynamic Band-Group Selection (DBGS) mechanism is used to adaptively select these band groups depending on channel conditions or network performance. DBGS can be configured to take into consideration many factors, including:
(i) Path Loss
(ii) Object and Body Shadowing
(iii) Inter-System Interference
(iv) Intra-System Interference
(v) Time Dispersion
(vi) Transmitter and receiver separation distances (location sensing)

DBGS may also consider QoS (Quality of Service) requirements for the different broadband channels. For example a latency sensitive audio visual stream application will have different ideal channel requirements compared with an email attachment download application. Other network performance metric could also be monitored including devices leaving/joining a UWB piconet.

Due to physical limitations of the channel, closely separated terminals with a strong LoS may use as high a frequency band as possible, whereas widely spaced terminals can use as low a frequency band as possible to account for path losses. In terms of interference avoidance, the 5 GHz band currently unused by MBOA can be adaptively reused. In a multi-user scenario, packet collisions with other users of a different piconet in the same Band Group can be avoided by going to another Band Group. Bands taken by terminals that subsequently ‘disappear’ from the network can also be dynamically reused. The overall system performance could be coupled with Adaptive Rate Change for maximum efficiency and throughput.

As each UWB channel is carried by multiple carrier frequencies, when channel conditions degrade, it is not a simple matter of selecting another carrier frequency to try to overcome the degraded performance; as is the case in narrow band systems.

Referring to FIG. 6, in the embodiment a number of band groups or groups of carrier frequencies are pre-defined, and the channel conditions for each of these groups of carrier frequencies is periodically monitored. The predefined groups of carrier frequencies may be those described above with respect to FIGS. 1-5. Each UWB channel is initially associated with or carried by one of the groups of frequencies, typically an available group with the best channel performance for the needs of the channel. For example if the channel is line of sight (LOS) and requires a high data rate, then a high frequency group may be used, whereas if the channel supports a large piconet then a lower frequency group may be used to overcome the signal path loss.

The method also determines other groups of carrier frequencies which could also be used by the UWB channel, typically in order of preference dependent on estimated or reported channel conditions including signal path loss, blocking or shadowing, intra-system interference (interference from other UWB channels), and inter-system interference (from other wireless technology systems such as Wi-Fi devices). A list of other groups in order of preference can then be stored for use when the currently assigned carrier frequencies group can no longer support the UWB channel at the desired channel performance level.

When a monitored performance parameter degrades below one or more thresholds, the method switches the UWB channel to the next group of carrier frequencies on the list. If this does not provide a satisfactory performance parameter, then the next group of carrier frequencies can be switched in to carry the UWB channel. The monitored performance parameter will typically be dependent on a number of factors, including channel performance measures such as received signal power, or bit error rate for example. It may also or alternatively be dependent on network performance parameters such as observed throughput compared with a QoS threshold for example. Cross layer optimisation can be utilised by incorporating performance measures from multiple layers including for example the physical layer (eg channel performance), MAC, network, transport and application layers.

If a device leaves, the frequency resource will be released immediately. If the device that left was the local coordinator, the next candidate (device with the next best resource and capabilities) will be appointed. If a new device joins, it first tries to establish piconet connection with its default band group. Once connected, it will be forwarded a list of alternative band groups by the nearest coordinator. Otherwise, it will keep on retrying until a connection is established. If the current piconet is full, its probing signal may be treated as interference. Thus one or more devices in the piconet may migrate to other frequency groups to make ‘space’ for it to join. After establishing connection, it starts scanning and updates its own channel and network conditions. All the other devices in the same piconet scan and update by opportunity or by schedule as well since they have now a new band group member.

As the list of other or alterative carrier frequency groups is predetermined, the UWB channel can be quickly switched to a new group without the need for measuring candidate carrier groups after determining that the current carrier group is no longer performing satisfactorily—for example the monitored performance parameter is below a threshold. This is advantageous in responding to rapidly changing channel conditions as might be expected in indoor applications. As a list or matrix of alternative carrier groups and their preference is small, this reduces memory requirements of the device implementing the method or part of it, and therefore the list can be provided to low cost devices to manage their own UWB channel rather than relying on a more powerful access point or centralised manager which would complicate signalling or control communications and slow the implementation of carrier group switching.

In the case of a DS-UWB low mode device interfering in band group 1 as illustrated in FIG. 2, any UWB channels carried by the TFCs of that band group can switch to any of the other band groups shown (2-5) in order to avoid that particular source of interference. Other factors such as signal path loss may be used to determine the preferences of these alterative band group options. Similarly, in FIG. 3, any UWB channels supported by band groups 3 and 4 may avoid the DS-UWB high mode device interference by switching to one of band groups 1, 2 or 5. The narrow band interference from the IEEE802.11x device interference illustrated in FIG. 4 may be avoided by UWB channels supported by band group 2 carriers by switching to one of band groups 1, 3-5; or if available the higher band groups 6-10 illustrated in FIG. 5.

In an embodiment a combination of channel metrics can be used to determine the performance parameter and determine alternative carrier groups.

Received carrier power (dB):

Devices operating in any mode can scan through the bands of their respective band group and measure the corresponding carrier power in each 528 MHz band or channel. This measurement is in the form of Received Signal Strength Indicator (RSSI) in the receiver. It may be necessary to have the RSSI averaged rather than just storing the largest or lowest instantaneous value.

Interference power (dB):

This metric determines the interference level in the frequency bands, which leads to making an accurate band group re-selection if necessary. There are basically two ways to perform such measurements:
(i) Frequency offset method:

This method involves setting an appropriate frequency offset between the established link and the frequency band to be measured.
(ii) Guard period method:

Alternatively the interference power can also be measured during the guard period between transmissions.

Information error rates:

Error rates can be measured by simply performing cyclic redundancy checks (CRC). Three common forms of measures include the bit error rate (BER), symbol error rate (SER) and packer error rate (PER).

Device location (m):

Certain UWB radios have an inherent ability to measure position accurately. The accuracy ranges from ±10 cm to ±60 cm, depending on the quality of the RF front ends.

Observed throughput (bps):

The throughput of each channel or band over a period of time may be logged by each device and fed back to the group assignment co-ordinator, so that it can determine the quality of each channel and dynamically re-assign band groups appropriately. For example, if the current throughput of a particular link does not meet the QoS requirement, the co-ordinator may then be requested to switch them to either a higher or a lower frequency band group. Dummy packets may also be used to measure the throughput if a quick measure is needed. The measured result is then compared to the required data rate. A score of 1 to 10 is then computed. 10 being the closest to the requested data rate, 1 being the furthest. This score can be used in a scoring matrix as described below.

Device battery power reserve (J):

Sustaining battery power in a device is becoming increasingly important. In general, battery life is extended by intelligent power control algorithms. Having this metric logged and fed back is also important, so that in the case when an appointed co-ordinator is running out of battery power, another one can be re-assigned immediately to take it's place. On the other hand, this metric can also be used to determine whether a device is fixed or mobile; i.e. a fixed device may have ‘infinite’ battery power status.

Node density:

This parameter indicates the total number of nodes present in a piconet. If each band group has a number of piconets, then the total number of nodes in that band group is the sum of all nodes in all piconets. The node density is normalised against the maximum allowable nodes in a band group. It is then converted to a scoring of 1 to 10. A score of 1 denotes the highest density and a score of 10, the lowest. This score is to be used in the scoring matrix.

These measurement metrics are translated into a scoring matrix (or simply a list) with different scores in each of the frequency band groups. The scores can correspond to the performance parameter for each band group, or some different measure could be used for the scores. The scoring matrix provides a quick and effective solution to populate the various band groups with maximum QoS levels for each device.

In an example implementation, the various measurement metrics are broken down into four distinct parameters: Channel quality, α, proximity, β (optional), QoS success rate, γ and node density, δ. Each of these parameters has a score of 1 to 10. The minimum and maximum scores are explained in Table 2.

TABLE 2

| | Score of 1 | Score of 10 |
|---|---|---|
| Channel Quality, α | Bad channel. The computed | Excellent channel. The |
| | BER, SER or PER given an | computed BER, SER or PER |
| | SNIR value is 10% or less than | given an SNIR value is 90% or |
| | the target value. | more than the target value |
| Proximity, β | Far apart (>10 m) | Close together (<2 m) |
| (optional) | | |
| QoS Success Rate, γ | Observed throughput is 10% or | Observed throughput is 90% or |
| | less than the requested data rate | more than the requested data |
| | | rate |
| Node Density, δ | Total number of nodes is | Total nodes is 10% or less than |
| | reaching 90% of more than the | the maximum allowable |
| | maximum allowable | |

With these parameters in place, a dynamic band group selection (DBGS) requesting device will then get a band group switching recommendation based on the following scoring matrix:

$$Scoring Matrix = ( \begin{matrix}\frac{{X}_{1} + {Y}_{1}}{C} & 0 & 0 & \cdot & 0 \\ 0 & \frac{{X}_{2} + {Y}_{2}}{C} & 0 & \cdot & 0 \\ 0 & 0 & \cdot & \cdot & 0 \\ \cdot & \cdot & \cdot & \cdot & 0 \\ 0 & 0 & 0 & 0 & \frac{{X}_{n} + {Y}_{n}}{C}\end{matrix} )$$

Where Xᵢ=αᵢ+βᵢ and Yᵢ=γᵢ+δᵢ, i=band group 1 to n. C is a constant depending on the number of parameters used. For example, if all four parameters are used, then C=40. On the other hand, if only three are used, then C=30. Each parameter is a factor of 10. This provides a flexibility depending how many parameters a system can measure. In this way, additional parameters can also be added in the future.

In other words, the diagonal matrix consists of scores for band groups both column wise and row wise. Each row, X is the sum of the parameters α and β (optional), and each column Y is the sum of parameters γ and δ. In this case the scores correspond to a performance parameter for each band group, which are determined from pre-defined channel and/or network metrics measured at a particular time or over a particular period. This same performance parameter is then monitored in real time by a device in order to determine whether a band group switch is required. Alternatively different performance parameters can be used for determining the scoring matrix and monitoring by the device.

Once this matrix is worked out, it is then passed on to the requesting device. The device will then re-tune based on the highest scoring. If channel and network conditions degrade sufficiently, as determined by monitoring the “real time” performance parameter of the currently allocated band group, the device then selects the next band group with the second highest score, and so on.

In an alternative arrangement, a simple list of band groups and their respective scores or preferences can be used.

Referring in more detail to FIG. 6, a method (200) of dynamically allocating carrier frequency groups for a UWB channel is illustrated. A new UWB channel will be required when a number of UWB capable devices negotiate with each other to form a piconet for example, or when a new device requests to join an existing piconet (205). Methods for negotiating or joining UWB piconets will be known to those skilled in the art, for example as defined in the MBOA proposals for MB-OFDM based UWB. These will typically involve a negotiating protocol carried out over a control channel. The method of dynamically allocating or selecting carrier frequency groups for the new UWB channel (dynamic band group selection algorithm or method—DBGS) then determines a DBGS coordinator(s) for controlling or coordinating allocation or selection of the band groups or groups of carrier frequencies to one or more UWB channels (210). Determination of a coordinator or multiple coordinating devices is described in more detail below. The coordinator allocates an initial group of carrier frequencies (band group) for carrying the broadband or UWB channel (215). This may be determined according to knowledge about other UWB channels coordinated by the coordinator, and/or by measurement of a performance parameter for all available band groups.

The performance parameter for each band group or predefined group of carrier frequencies is made up of a combination of measurement metrics as described above. For example the performance parameter may be calculated according to the equations used for the scoring matrix described above—(X₁+Y₁)/C. The measurement metrics used are typically determined using measurements made by the devices requesting a UWB channel and which will be allocated a band group by the coordinating device. Alternatively, the coordinating device may determine all the measurement metrics. As a further alternative, the performance parameters may be estimated, or a combination of estimation and measurement may be used. The coordinating device then performs calculations to determine a scoring matrix as described above, or a simple scoring list, for each of the available band groups or predefined groups of carrier frequencies. The band group having the best or highest performance parameter will be allocated as the initial carrier frequency group (215), with the other band groups identified as alternative carrier frequency groups (220), each having a score depending on their respective performance parameter. These scores can then be used for dynamic band group selection if conditions on the initially allocated band group degrade.

In an alternative arrangement, the initial carrier frequency group may be a default group of carrier frequencies such as the Band 1 group of the MBOA proposal (215). The alternative band groups may then be subsequently identified (220) following gathering of measurement metrics and performance of a scoring matrix calculation.

The scoring matrix can then be forwarded to each device associated with the UWB channel, and stored at the device(s). Each UWB channel or piconet may have a coordinating device which instructs the other devices in the piconet on which band group to use for the UWB channel or piconet as described below, or alternatively some other method of coordinating the band group to use for the piconet could be used. As the scoring matrix is calculated by a coordinator, this relieves battery powered devices with low processing capabilities from this task. Furthermore, the scoring matrix can be stored in the devices memory, requiring little memory resources.

Once the initial carrier frequency group has been allocated (215) and the alternative carrier frequency groups identified (220) in the stored scoring matrix, the device periodically monitors the UWB channel and/or network performance (ie performance parameter) of the currently allocated band group (225). This may be implemented simply by re-measuring the metrics taken already and used for the scoring matrix to provide the alternative carrier frequency groups, in order to determine the performance parameter for the current band group. In more sophisticated implementations, monitoring the channel and/or network performance may involve determining whether the allocated band group is meeting the QoS requirements of the UWB channel, which may require different measurements, and/or knowledge of the current applications using the UWB channel for transferring data. For example if a video call has just started this will require a lower latency tolerance, but may tolerate a higher error rate, whereas an email transfer may tolerate a much higher latency level but much lower error rate.

The method then determines whether the monitored channel performance has degraded below a threshold (230). This may simply involve determining whether the most recently determined performance parameter (or score) of the currently allocated band group has fallen below any of the performance parameters (or scores) for other band groups within the scoring matrix. Alternatively this step (230) may involve comparing the current QoS requirements for the UWB channel with performance metrics supported by the currently allocated band group, and determining whether these can still be supported by the current band group.

If the monitored channel performance is acceptable (230N), then the method determines whether the alternative carrier frequency groups (eg the scoring matrix) need to be updated (235). This is done periodically as channel conditions change over time, however it need not be done as often as monitoring the current performance parameter which is more critical to adequate UWB channel provision. If a scoring matrix update is not overdue (235N), the method returns to monitor the performance parameter of the currently allocated band group (225). If a scoring matrix update is due (235Y), then the method returns to the identify alternative carrier frequency groups step (220), which may involve determining measurement metric, forwarding these to the coordinator, and receiving from the coordinator an updated scoring matrix.

If the monitored performance parameter is not acceptable (230Y), then the method re-allocates the UWB or otherwise defined broadband channel to one of the alternative groups of carrier frequencies (240). As noted above, this can be implemented simply by re-allocating the UWB channel to the group of carrier frequencies having the next highest score in the stored scoring matrix.

The method then returns to the monitoring performance parameter step (225), using the newly (re-)allocated group of carrier frequencies. If the monitored performance parameter is still not adequate (230Y), then a further re-allocation is implemented and so on, until adequate performance parameter is achieved. As the channel conditions are dynamic, it may be the case that the scores for each band group incorporated in the stored scoring matrix no longer correspond to current channel conditions. However by using the stored scoring matrix or list arrangement, latency within the system is reduced, as it is not necessary to measure and calculate the scoring matrix whenever a change in carrier frequency groups is required.

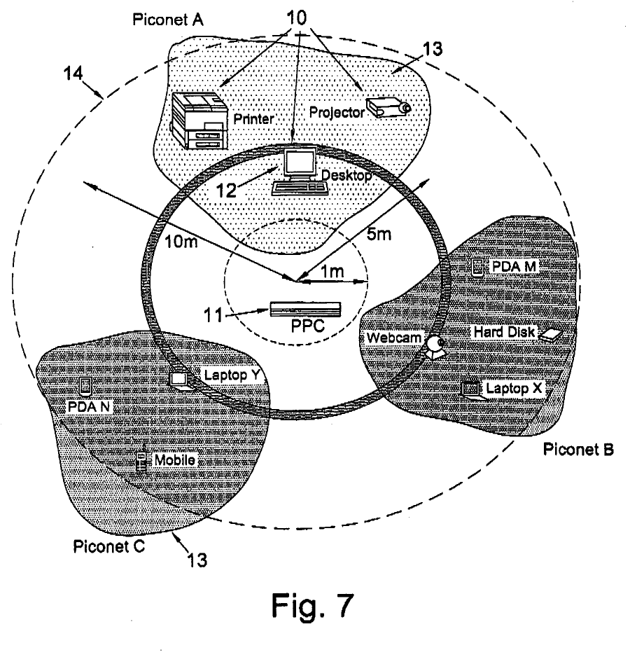

Referring to FIG. 7, an embodiment is shown in which various UWB devices within an area having multiple piconets provided by multiple UWB channels are assigned partial dynamic band group selection co-ordination roles. The embodiment comprises a number of UWB piconet capable wireless devices 10, a parent piconet coordinator (PPC) 11, and a number of child piconet coordinators (CPC) 12. The PPC 11 has a WLAN coverage area 14 of around 10 m such that it can communicate with a number of devices 10. The other devices negotiate with each other to form individual piconets 13. The three active piconets 13 shown each have a CPC 12.

UWB devices are capable of providing location information. By exploiting this advantage, the PPC 11 can determine the location of the furthest and the closest device 10. With this information, it can then compute an optimal region (usually half the maximum coverage distance, shown as a grey line in FIG. 7) where it will be most suitable to keep track of the individual local piconet's channel and network information. Devices that are closest to this central radius (grey line) may then be appointed as the CPC 12 for the respective piconet 13. As many of these CPC devices 12 may be mobile, upon leaving the vicinity, the PPC can be configured to re-assign another device 10 dynamically as the CPC 12 for the respective piconet 13. In the case where the PPC 11 is a mobile device, it can be configured to re-assign another device 10 to take over as the PPC 11 upon leaving the operating zone. In the case where a PPC 11 suddenly disappears, a suitable CPC 12 can be promoted to a PPC 11 automatically after a predetermined time.

Knowing the locations of possibly every device in the network, the PPC 11 can then assign the appropriate devices to be CPCs 12 to help gather and update timely channel and network information. Additionally, knowing the distance between a transmitting and receiving device, the PPC 11 could also make sure that the band group they are assigned is appropriate for the range (i.e. long range uses a lower frequency band).

In FIG. 7, the desktop or the printer could be appointed as a fixed CPC 12 for piconet A, depending upon which has the most resources and capability, and at the same time having the strongest link with the PPC 11. Similarly, the webcam and laptop Y could be the best candidates to be assigned as mobile CPCs for piconets B and C respectively.

With this scenario in a database or suitable memory structure, the PPC 11 may then dynamically assign different band groups for each piconet 13 so that they do not interfere with one another. As the frequency bands span from low (3.1 GHz) to high (10.6 GHz) frequencies, the PPC 11 could in this case assign high frequency band groups (mode IV or V) to piconet A—assuming they all have the capability to operate in these modes. Scanning the channels and with information gathered by the CPCs 12, if the current network is free from IEEE 802.11a or 802.11n, standard devices which operate at the 5 GHz band, the PPC 11 can then assign piconets B and C to operate in mode II (Band Group 2 with different TFCs), depending again on their capabilities.

In one implementation, each device 10 in the UWB Multi-Band OFDM network has the task to pre-measure the links they establish with each other. This information is then delivered or fed back in two ways to the coordinators (PPC 11 and CPC 12). Pre-measurement of the channel and/or network environment is attractive because the Parent Piconet Coordinator (PPC) 11 is relieved from being overloaded with measurement activities. Moreover, the devices 10 themselves give the most accurate measurement using their own links.

The DBGS process is thus optimised by having coordinators to provide timely information and also having location awareness capability to aid in making decision to assign frequency bands appropriately. In most case, the QoS required by each application on the device will also be considered if they are available.

There are two ways to feedback the channel and network information to the PPC 11. One way is for a device 10 to send a packet directly to the PPC 11 at the appropriate time and the second way is to feedback via one or more other devices 10, creating alternative routes. Feedback via relaying will depend highly on the accumulated channel and network knowledge such as alternative routes can be established, in case a direct route is not available.

If there are fixed devices with the ability to operate in all modes present in the network, these may advantageously serve as fixed PPC 11 or Child Piconet Coordinator (CPC) 12. The role of a coordinator is to gather pre-measured channel and network environment information at regular or scheduled intervals which is fed back to the PPC 11 in a timely fashion. This may be one of the most effective methods to keep the channel state information (CSI) and the network environment (devices appearing and disappearing) up to date. However, additional dedicated fixed coordinators may imply extra costs. Such arrangements may be more financially viable in hot spot areas.

Alternatively a mobile device may be used, and this addresses the situation where a dedicated fixed device may be unavailable or that the presence of a device being able to operate in certain mode(s) is unavailable. A mobile device within a specified proximity can then be assigned by the PPC 11 to serve as the mobile CPC 12. As mentioned above, pre-measured channel and network environment information is then gathered at regular or scheduled intervals and fed back to the PPC 11 for further processing in a timely fashion.

Depending on the QoS requirements of the particular applications, partial channel knowledge may just be enough for the PPC 11 to perform DBGS (dynamic band group selection). For example, applications which require high data rates and low latency such as audio and video streaming, may not be able to update full channel knowledge regularly. In this case, partial knowledge can be used. Partial channel state information may be just the high data rate point-to-point channel in use, and partial network information may be just the two interacting devices in this example. Further more, such devices (HDTV, DVD players, etc) normally are not mobile. On the other hand, full channel and network knowledge can be gathered occasionally by a device which is ‘free’ or in power save mode.

To perform a full measurement, a device first has to be capable of operating in all modes (i.e. be able to switch to all bands). Additionally, the switching and settling time may also dominate the entire measurement period. The total measurement time can be computed in the following way:
Total Measurement Time=Number of Bands×(Switching Time+Settling Time+Measurement Time in that band)

For partial measurement, the number of bands will just be limited to two or three depending on the operating mode.

Channel and network measurements can be performed at regular scheduled or random intervals. This depends on the application scenario. In the above examples, fixed CPCs 12 with “unlimited” power sources (ie not battery powered) can be used to make regular measurements even during DBGS, whereas the mobile CPC 12 may only be able to make the measurements opportunistically. On the other hand, measurements can also be done when a new device 10 joins the network 14.

In the MBOA standard, a centralised topology is employed, and a central device (PPC) assumes the role of the entire network's access and resource management. Crude measurement mechanisms are used for measuring the relative quality of alternative channels. Compared to the distributed topology, it is less flexible for the DBGS mechanism, however it is relatively less complex as most processing is done at the PPC. Furthermore, the PPC is assumed to have unlimited power resources, be able to operate in all modes and have enough memory to hold all required channel and network data. Another advantage for a centralised topology is that latency is very much reduced, especially for WPAN devices that normally work only within a 10 m range. In this aspect, the network could be more reliable, though less flexible by operating in this manner.

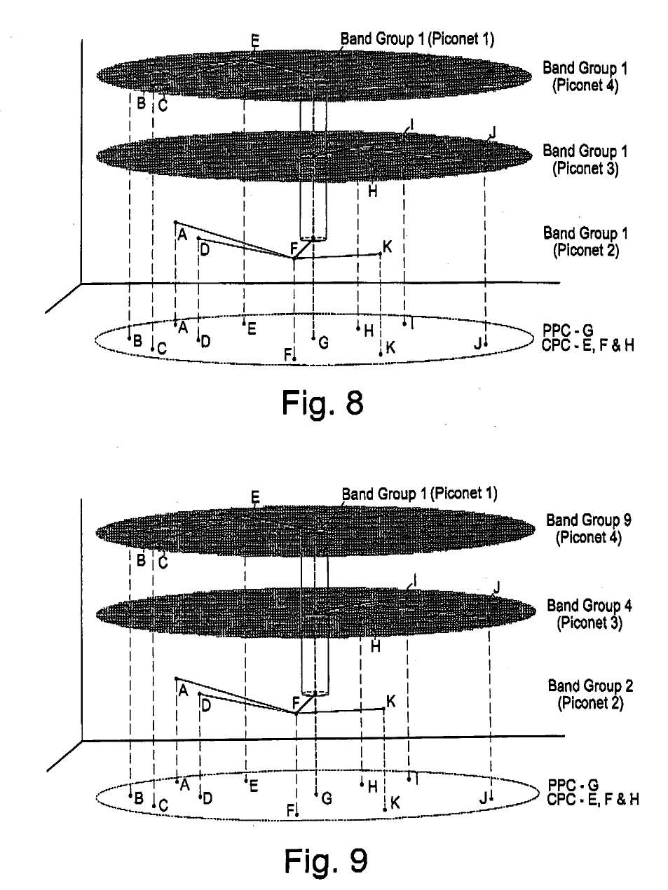

FIG. 8 illustrates a WLAN topology in which DBGS is not applied; respectively in 3D and 2D. The channel or carrier frequency groups for each piconet are indicated. In this scenario, Node G is being assigned as the PPC of piconet 1 in Band Group 1. The other piconets (2, 3 and 4) are child or neighbours to piconet 1. Nodes E, H and F serve as CPCs in this case. The PPC piconet (Piconet 1) is illustrated as a ‘pipeline’ to show that node G is also the information gateway in that it connects all other nodes to the wider area networks like LAN and the internet.

Referring now to FIG. 9, when DBGS is employed, the nodes start to exchange information and ultimately after some time, the PPC—node G, will have enough information to re-assign suitable band groups to each node. In this case, node G has become aware that nodes E, B and C requires high QoS with a low latency requirement (e.g. real time audio/video streaming), and that they maintain good LoS with each other most of time—high SNR values between them. At this point, it can then dynamically switch them to any of the available high frequency band groups. In so doing, congestion and thus interference in Band Group 1 is also reduced.

To improve link performance even further, the PPC re-assigns each remaining piconet with a different band group, making use of the entire UWB microwave and/or millimetre-wave spectrum resources. The result is that nodes E, B and C are re-tuned to operate in the millimetre-wave band group 9, the other nodes remain in the microwave bands with each piconet in Band Group 1, 2 and 4. Typically the parent piconet (Piconet 1) has priority over the others to operate within the most robust band group.

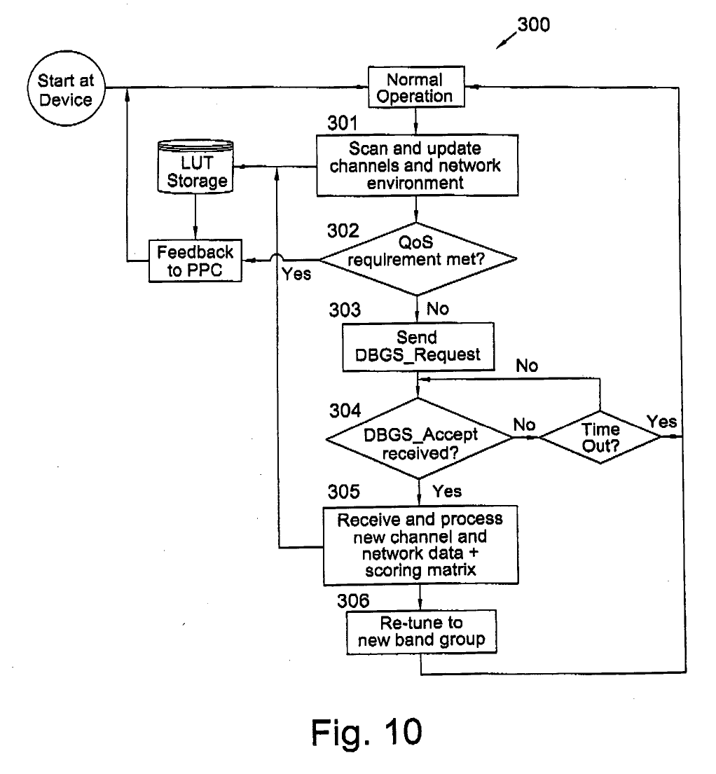

A DBGS algorithm according to an embodiment is described with respect to FIGS. 10-12. The algorithm provides a systematic way to abstract, collate and distribute relevant information about the changing physical nature of the channel and the dynamics of the network environment by all participating devices. The PPC is presumed to be most sophisticated and to possess information about the entire UWB spectrum and all the existing piconets that formed the network. As each device may not be capable of operating on two or more modes, only information relevant to its modes of operation shall be distributed, thus optimising the use of memory in these devices.

Each device is configured to measure, log and feedback its own channel information, network activities, and channel requirements (eg QoS levels). Such information (device performance data) is organised as a form of a look-up-table (LUT). The LUT for each device will contain the following information:

Current Band Group Number

Channel Parameters: Carrier power, interference power, SNIR, measured throughput

Network Parameters: Devices' locations, remaining battery power(s) for each device, QoS level requirement (e.g. data rate, traffic types)

Scoring Matrix: List of recommended re-selection band groups provided by the PPC. Score of 0 to 1. 1 being the most recommended or having the highest probability of achieving the required QoS level.

The PPC and fixed CPC capable of all modes will additionally contain LUTs for all Band Groups and devices (device performance data). Assigned mobile CPCs will have LUTs only relevant to their set ups. The list of recommended Band Groups (eg a scoring matrix) is used when a device is required to re-tune to another frequency band group; and should initially select the most highly recommended one (highest score). If the channel and environment change before or while it re-tunes, then the device may go for the second or third choice in the list. This strategy reduces latency during re-tuning, as it avoids having to re-measure, update, feedback and wait for the PPC to recommend another Band Group.

LUTs are transferred between the devices, including CPCs and PPC, in order to inform decisions about the efficient allocation or selection of band groups for the different piconets or UWB channels.

Referring to FIG. 10, a device entering a piconet (Piconet 1) initially attempts to establish a UWB channel using a default Band Group (eg Band Group 1). After the default mode and hence channel is established, an LUT is received from its coordinator (CPC or PPC)—this is described in more detail below. The new device then makes a fresh scan of its initially assigned channel (from the received LUT or device performance data) and surroundings (301). The LUT received will be updated immediately and stored in its memory. With a fresh set of measured parameters, it checks to see if the channel and network conditions are able to satisfy its required QoS (302). If they do, then the updated LUT is fed back to the closest CPC or to the PPC directly. If the channel does not satisfy the QoS requirement, a DBGS_REQUEST flag is then sent out to the CPC or PPC to request for a new Band Group (303). It then polls for the DBGS_ACCEPT flag (304). If it does not receive the flag for a specified time, it then times itself out and returns to normal operation. The process starts again according to schedule. An appropriate time scheduling method may also be negotiated at this point. When the flag is received, the device processes the new data which includes the scoring matrix identifying alternative groups of carrier frequencies (305). At this point, the device starts to re-tune and establish a new connection at one of the recommended Band Groups in the list (306). Then the operation returns to the normal state and the process starts again according to the schedule. An appropriate scheduling method may also be negotiated at this point. Each device scans and updates the network environment (301), and this is feedback to the CPC and PPC. This data is processed to determine an updated scoring matrix, which is then redistributed to all devices (305). Thus all devices in a piconet will be aware of which group of carrier frequencies to re-tune to when appropriate (306).

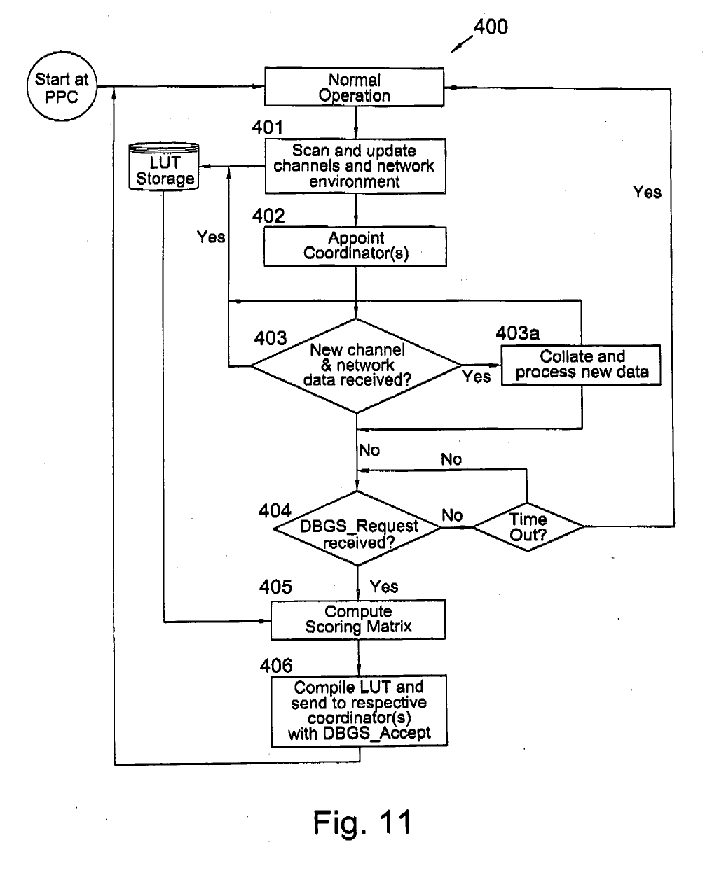

DBGS coordinators are assigned when each piconet is initially set up. This is illustrated in FIG. 11 which shows operation of a parent piconet coordinator (PPC). Firstly, it scans and updates the entire UWB spectrum and the network environment in all modes (401). It then stores the channel and network information into its memory. Knowing the number of existing devices after scanning the environment, it then computes strategic zones to appoint CPCs (402). It then polls for new channel and network data (403). These are forwarded by appointed CPCs. In the case where there is only one device, then that device will automatically be appointed. If new information arrives, it then collates, processes and update all the information (403a). Now it polls for DBGS_REQUEST flags. If there are no requests after a specified time period, it then times out and returns to normal operation (404). If there are requests, it then retrieves the latest information from its storage and computes the scoring matrix for re-tuning according to the capability of the requesting device (405). At this point, LUTs relevant to the requesting device are then compiled and sent back to its CPC with a DBGS_ACCEPT flag (406). It then returns to normal operation.

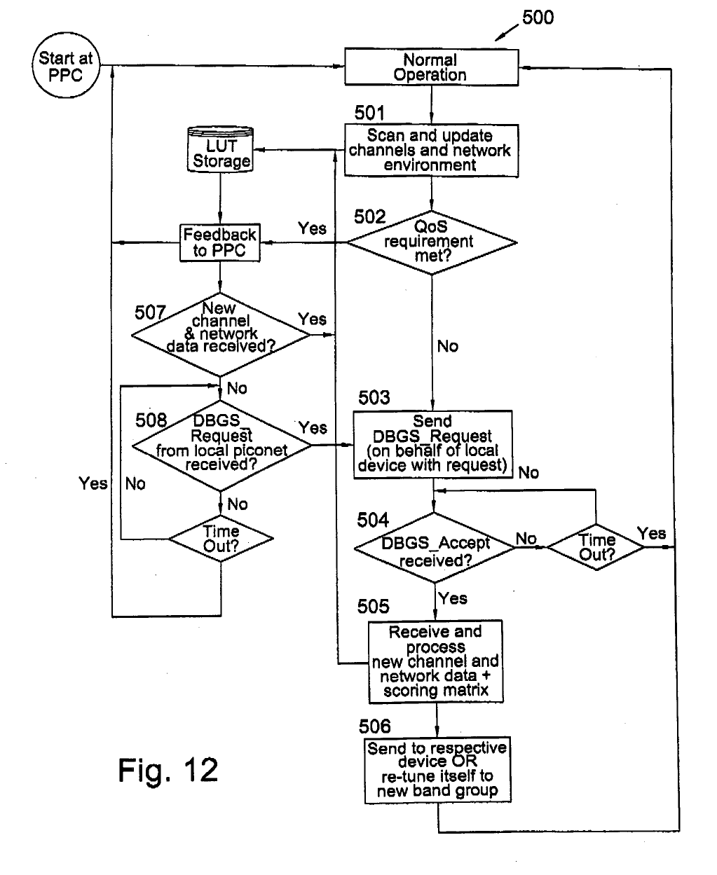

Once appointed as a CPC, a device acts as a relay between other devices in its piconet and the PPC. This is illustrated in the flow chart of FIG. 12. During the dynamic selection phase, the steps are the same with the initial phases for a PPC and a new device. A CPC however assumes part of the role of a PPC and thus has these two additional steps as shown in FIG. 12. The CPC Checks that new channel and network information are being sent by devices in its piconet. If they are, then this is collated and updated into its current version of the LUT with respect to the Band Group. It then forwards the new LUT to the PPC (507). Next it polls for DBGS_REQUEST flags sent by members of its piconet. If there are no requests after a specified time period, it then times out and returns to normal operation. On the other hand if there are requests, it skips to sending the DBGS_REQUEST on behalf of the local device in its piconet (508). This last step may also require relaying the DBGS_REQUEST to the PPC, in case the link between the requesting device and the PPC is weak or difficult to establish.

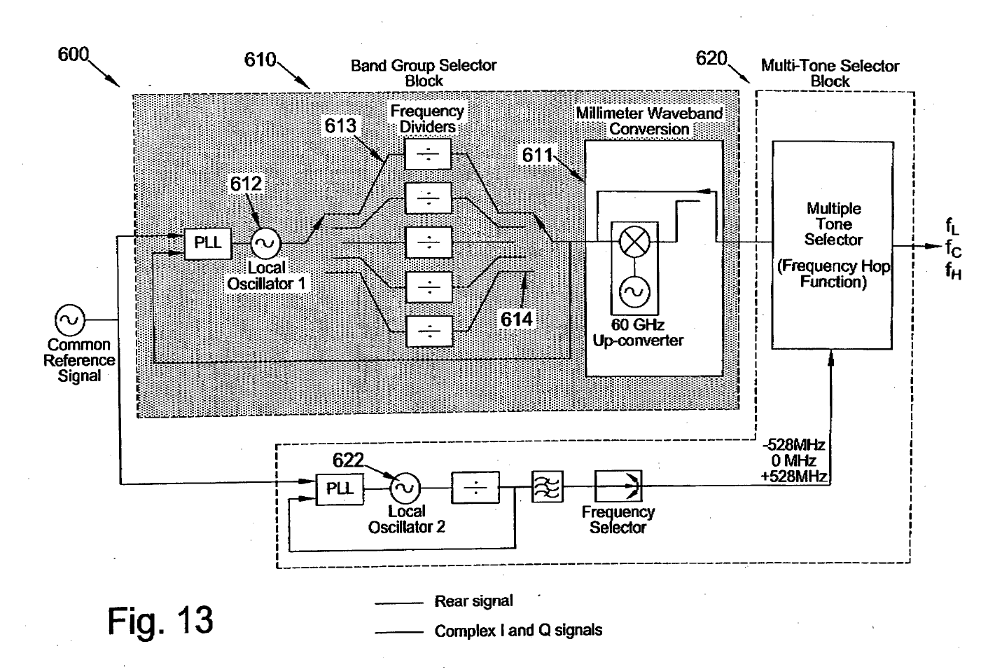

A further embodiment is described with respect to FIG. 13 which shows a block diagram for an OFDM based UWB device 600 providing frequency switching or hopping within a band group. A first block 610 generates and switches to a desired band group. An optional 60 GHz up-conversion block 611 is also included to extend the UWB operation to the millimetre-wave ISM bands. A second multi-tone selector block 620 generates and switches between the centre (f_{C}), lower (f_{L}) and upper (f_{H}) frequencies within a band, each tone with a bandwidth of 528 MHz.

In the Band Group Selector block 610, the output signal from a high frequency local oscillator 612 travels though a frequency divider 613 (depending on the switch) in order to synthesise the centre frequencies, f_{C}, of band groups 1 to 5. Band groups 6 to 10 can be selected by enabling the 60 GHz up-conversion block 611. The process generates in-phase and quadrature (complex) signals at the output of the dividers. The appropriate band group selection at the selection switch 614 is provided by the DBGS algorithm. With this arrangement, the diversity of various frequency band groups can be exploited in both the microwave and the millimetre-wave spectrums, giving a total bandwidth of 14.5 GHz.

At the Multi-Tone Selector Block 620, the complex signal output from the Band Group Selector Block 610 is mixed with the complex tone generated by a complex tone generator 622 between the three frequencies (−528 MHz, 0 Hz and +528 MHz). The resultant signal (f_{L}, f_{C} and f_{H}) is thus frequency shifted either up or down in frequency by selecting the appropriate sign of the 528 MHz signals.

Whilst the embodiments have been discussed with respect to the MBOA UWB proposal, they could also be applied to any other communications system using multiple carrier signals for each broadband channel. Furthermore, the broadband channel need not be a UWB channel, but could be a narrower channel, though still carried by multiple carrier signals.

The skilled person will recognise that the above-described apparatus and methods may be embodied as processor control code, for example on a carrier medium such as a disk, CD- or DVD-ROM, programmed memory such as read only memory (Firmware), or on a data carrier such as an optical or electrical signal carrier. For many applications embodiments of the invention will be implemented on a DSP (Digital Signal Processor), ASIC (Application Specific Integrated Circuit) or FPGA (Field Programmable Gate Array). Thus the code may comprise conventional programme code or microcode or, for example code for setting up or controlling an ASIC or FPGA. The code may also comprise code for dynamically configuring re-configurable apparatus such as re-programmable logic gate arrays. Similarly the code may comprise code for a hardware description language such as Verilog™ or VHDL (Very high speed integrated circuit Hardware Description Language). As the skilled person will appreciate, the code may be distributed between a plurality of coupled components in communication with one another. Where appropriate, the embodiments may also be implemented using code running on a field-(re)programmable analogue array or similar device in order to configure analogue hardware.

The skilled person will also appreciate that the various embodiments and specific features described with respect to them could be freely combined with the other embodiments or their specifically described features in general accordance with the above teaching. The skilled person will also recognise that various alterations and modifications can be made to specific examples described without departing from the scope of the appended claims.

1. A method of dynamically selecting carrier frequencies for carrying a broadband channel, the method comprising:
allocate a group of carrier frequencies for carrying the broadband channel;
identify a number of alterative groups of carrier frequencies;
monitor a performance parameter of the broadband channel for the allocated group of carrier frequencies;
re-allocate the broadband channel to be carried by one of the alternative groups of carrier frequencies in response to the monitored channel performance degrading below a threshold.

2. A method according to claim 1 wherein the broadband channel is a UWB channel and the groups of carrier frequencies correspond to OFDM symbols in respective predefined band groups.

3. A method according to claim 1 wherein the allocated and alternative groups of carrier frequencies are determined by a coordinator and forwarded to a device communicating with the broadband channel, and wherein the re-allocation step is taken by the device having received and stored the allocated and alternative groups of carrier frequencies.

4. A method according to claim 3 further comprising:
initially allocating a default group of carrier frequencies;
determining a performance data structure comprising performance metrics associated with the initially allocated group of carrier frequencies;
feeding back the data structure to the coordinator for processing with other data structures feedback from other devices in order to determine a scoring matrix identifying the alternative groups of carrier frequencies;
receiving the scoring matrix from the coordinator.

5. A method of allocating groups of carrier frequencies for carrying a broadband channel, the method comprising:
determining channel performance parameters for a number of groups of carrier frequencies for carrying the broadband channel;
allocating the group of carrier frequencies for carrying the broadband channel having the best channel performance parameter;
identifying a number of alterative groups of carrier frequencies for re-allocating the broadband channel to when the measured channel performance parameter degrades below a predetermined threshold.

6. A method of dynamically selecting carrier frequencies for carrying a broadband channel, the method comprising:
receiving an allocated group of carrier frequencies for carrying the broadband channel;
receiving a number of alterative groups of carrier frequencies;
measuring a channel performance parameter for the broadband channel;
re-allocating the broadband channel to be carried by one of the alternative groups of carrier frequencies in response to the measured channel performance parameter degrading below a predetermined threshold.

7. A computer program product comprising computer program code which when executed on a computer causes the computer to perform a method according to claim 1.

8. A system for dynamically selecting carrier frequencies for carrying a broadband channel, the system comprising:
means for allocating a group of carrier frequencies for carrying the broadband channel;
means for identifying a number of alterative groups of carrier frequencies;
means for monitoring a performance parameter of the broadband channel for the allocated group of carrier frequencies;
means for re-allocating the broadband channel to be carried by one of the alternative groups of carrier frequencies in response to the monitored channel performance degrading below a threshold.

9. A system according to claim 8 wherein the broadband channel is a UWB channel and the groups of carrier frequencies correspond to OFDM symbols in respective predefined band groups.

10. A system according to claim 8 wherein the performance parameter is dependent on a channel performance measurement and/or a network performance measurement.

11. A system according to claim 10 wherein the channel performance parameter comprises one or a combination of the following: received carrier power; interference power; information error rate; estimated distance between transceivers; throughput; power reserves; transceiver density.

12. A system according to claim 8 further comprising means for determining a performance parameter for each group of carrier frequencies, and initially allocating the group of carrier frequencies with the highest determined performance parameter.

13. A system according to claim 12 wherein the broadband channel re-allocation means is arranged to re-allocate to the alternative group of carrier frequencies having the next highest determined performance parameter.

14. A system according to claim 8 wherein the allocation means is arranged to allocate the channel to a default group of carrier frequencies, and the system further comprises means for determining a performance parameter for a number of other groups of carrier frequencies in order to identify the alternative groups of carrier frequencies.

15. A system according to claim 8 wherein the threshold is a performance parameter determined for one of the alternative groups of carrier frequencies or a predetermined measurement metric value.

16. A system according to claim 8 further comprising a coordinator arranged to determine the allocated and alternative groups of carrier frequencies and to forward these to a device communicating with the broadband channel, and wherein the device is arranged to re-allocate the group of carrier frequencies having received and stored the allocated and alternative groups of carrier frequencies.

17. A system according to claim 16 wherein the device comprises the monitoring means.

18. A system according to claim 16 further comprising:
means for initially allocating a default group of carrier frequencies;
means for determining a performance data structure comprising performance metrics associated with the initially allocated group of carrier frequencies;
means for feeding back the data structure to the coordinator for processing with other data structures feedback from other devices in order to determine a scoring matrix identifying the alternative groups of carrier frequencies;
means for receiving the scoring matrix from the coordinator.

19. A coordinating apparatus for allocating groups of carrier frequencies to a device for carrying a broadband channel, the apparatus comprising:
means for determining performance parameters for a number of groups of carrier frequencies for carrying the broadband channel;
means for allocating the group of carrier frequencies for carrying the broadband channel having the best channel performance parameter;
means for identifying a number of alterative groups of carrier frequencies for re-allocating the broadband channel to when the measured channel performance parameter degrades below a predetermined threshold.

20. A device for dynamically selecting carrier frequencies for carrying a broadband channel, the device comprising:
means for receiving an allocated group of carrier frequencies for carrying the broadband channel;
means for receiving a number of alterative groups of carrier frequencies;
means for measuring a channel performance parameter for the broadband channel;
means for re-allocating the broadband channel to be carried by one of the alternative groups of carrier frequencies in response to the measured channel performance parameter degrading below a predetermined threshold.
